(19) United States
(12) Patent Application Publication
(10) Pub. No.: US 2009/0149078 A1
(43) Pub. Date: Jun. 11, 2009

(54) Connector

(75) Inventors: Hayato Kondo, Osaka (JP); Takayuki Nagata, Osaka (JP); Takahisa Ohtsuji, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: HOSIDEN CORPORATION, Osaka (JP)

(21) Appl. No.: 12/255,195

(22) Filed: Oct. 21, 2008

(30) Foreign Application Priority Data
Oct. 26, 2007 (JP) 2007-278999

(51) Int. Cl. H01R 24/00

(52) U.S. Cl. 439/660

(57) ABSTRACT

A connector comprises a plug, and a receptacle mounted on a substrate and having an opening into which the plug is inserted. The receptacle has a housing for holding a receptacle-side terminal part in an interior of a tubular shield cover that forms the opening. An engagement projection part provided to the plug engages with an engagement hole provided to a region of the shield cover of the receptacle that faces the substrate when the plug is inserted into the receptacle, and in a state in which the receptacle is mounted on the substrate, the region of the shield cover to which the engagement hole is provided is positioned away from the substrate by a set distance.

### BACKGROUND OF THE INVENTION

1. Field of the Invention

The present invention relates to a connector comprising a plug and a receptacle mounted on a substrate and having an opening into which the plug is inserted, and relates more particularly to a connector constructed so that the receptacle has a housing for holding a receptacle-side terminal part in the interior of a tubular shield cover that forms an opening, and when the plug is inserted into the receptacle an engagement projection part provided to the plug engages with an engagement hole provided to the receptacle.

2. Description of the Related Art

Connectors comprising a plug and a receptacle are used for connecting a variety of devices to wiring patterns on circuit boards in the interior of a variety of electrical devices. For example, a plug is provided to a distal end of wiring linked to a device, a receptacle is provided on the wiring pattern of a circuit board, and the plug is inserted into the receptacle, whereby the device and the wiring pattern are connected. In the connector described in Japanese Patent No. 3966414, the receptacle has a resin housing for holding a receptacle-side terminal part in the interior of a tubular shield cover forming an opening. An engagement hole with which an engagement projection part provided to the plug engages when the plug is inserted via the opening of the receptacle is provided to the top surface of the receptacle. As a result, once the plug has been inserted into the receptacle, the inserted state will be maintained during the time that the engagement projection part of the plug is in engagement with the engagement hole of the receptacle.

Typically, a plurality of wires are arranged in a predetermined sequence within the plug, so that the wires can be bundled together and connected as a single entity to the receptacle. Similarly, a receptacle-side terminal part provided to the receptacle also has a plurality of terminals arranged in the same sequence, so as to properly connect with the arranged wires. The plurality of terminals in the receptacle-side terminal part of the receptacle may also be arranged in the opposite sequence from the sequence mentioned above, in which case the plug may be reversed and inserted into the receptacle (i.e., the plug may be reverse-mounted).

In the connector described in Japanese Patent No. 3966414, when the plug is reverse-mounted, it is necessary that the engagement hole, which is provided to the top surface of the shield cover of the receptacle when normal mounting is performed, be provided to the bottom surface of the shield cover. Specifically, during normal mounting, the engagement projection part of the plug engages at the top surface of the shield cover of the receptacle; however, when reverse-mounting is performed, the engagement projection part of the plug will engage with the bottom surface of the shield cover (i.e., the substrate side). Therefore, the engagement projection part of the plug will interfere with the substrate, and a problem will arise in that the engagement projection part cannot reliably engage with the engagement hole.

With the foregoing aspects of the prior art in view, it is an object of the present invention to provide a connector in which the engagement projection part of a plug can reliably engage with the engagement hole of a receptacle when the plug is reverse-mounted.

### SUMMARY OF THE INVENTION

The connector according to the present invention and used to achieve the aforesaid object is characterized in comprising a plug, and a receptacle mounted on a substrate, and having an opening into which the plug is inserted; the receptacle having a housing for holding a receptacle-side terminal part in an interior of a tubular shield cover that forms the opening of the receptacle; wherein an engagement projection part provided to the plug engages with an engagement hole provided to a region of the shield cover of the receptacle that faces the substrate when the plug is inserted into the receptacle, and in a state in which the receptacle is mounted on the substrate, the region of the shield cover to which the engagement hole is provided is positioned away from the substrate by a set distance.

According to the above aspect, even in a state where the plug has been inserted into the receptacle in a reverse-mounted form and the engagement projection part of the plug has engaged with the engagement hole of the shield cover, a space sufficient to prevent the engagement projection part from interfering with the substrate will be ensured between the region to which the engagement hole is provided and the substrate.

Accordingly, it is possible to provide a connector in which the engagement projection part of a plug can reliably engage with the engagement hole of a receptacle when the plug is reverse-mounted.

According to another aspect of the connector according to the present invention, the shield cover is a tubular body that is rectangular in cross-section, and each of a plurality of cutout pieces cut out and formed from the tubular body is inserted and locked into a plurality of through-holes provided to the substrate, whereby a bottom surface of the shield cover is mounted facing the substrate.

According to the above aspect, the cutout pieces are caused to lock into the substrate, whereby the receptacle can be reliably mounted on the substrate.

According to another aspect of the connector according to the present invention, base parts of the cutout pieces are formed wider than tip parts, whereby a part of the cutout pieces is inserted into the substrate when the receptacle is mounted on the substrate.

According to the above aspect, the cutout pieces are not entirely inserted into the substrate, but have a portion which is not inserted into the substrate. Therefore, the shield cover will assume a state of being suspended above the substrate by an amount corresponding to the uninserted portion. As a result, even in a state where the plug has been inserted into the receptacle in a reverse-mounted form and the engagement projection part of the plug has engaged with the engagement hole of the shield cover, a space sufficient to prevent the engagement projection part from interfering with the substrate will be ensured between the region to which the engagement hole is provided and the substrate.

According to another aspect of the connector according to the present invention, cutout pieces included among the plurality of cutout pieces and formed nearer to the opening than to the region of the shield cover to which the engagement hole is provided, are cut out and formed from a surface different from the surface to which the engagement hole is provided.

If the cutout pieces are cut out and formed from the same bottom surface to which the engagement hole is provided, the holes created in the shield cover by cutting out from the shield cover portions for the cutout pieces will be created in the same bottom surface in which the engagement hole is formed. In that case, the cutout pieces will be formed in the shield cover nearer to the opening than to the region to which the engagement hole is provided. As the plug is inserted into the receptacle, the fact that the cutout piece portions have been cut out may lead to the engagement projection part of the plug getting stuck in the holes formed in the shield cover before the engagement projection part has reached the engagement hole.

However, according to the above aspect, this problem does not arise because the cutout pieces which are formed in the shield cover nearer to the opening than to the region to which the engagement hole is provided, are cut out and formed from a surface that is different from the surface to which the engagement hole is provided. Accordingly, the engagement projection part of the plug can be caused to reliably engage with the engagement hole of the shield cover.

According to another aspect of the connector according to the present invention, a spacer member is provided between the shield cover and the substrate.

According to the above aspect, the shield cover will assume a state of being suspended above the substrate by an amount corresponding to the thickness of the spacer member. As a result, even in a state where the plug has been inserted into the receptacle in a reverse-mounted form and the engagement projection part of the plug has engaged with the engagement hole of the shield cover, a space sufficient to prevent the engagement projection part from interfering with the substrate will be ensured between the region to which the engagement hole is provided and the substrate.

### BRIEF DESCRIPTION OF THE DRAWINGS

FIG. 1 is a perspective view of a receptacle;

FIG. 2 is a front view of the receptacle;

FIG. 3 is a side view of the receptacle;

FIG. 4 is a bottom view of the receptacle;

FIG. 5 is a cross-sectional view showing a state in which a plug has been inserted into the receptacle;

FIG. 6 is a side view of the receptacle; and

FIG. 7 is a cross-sectional view showing a state in which a plug has been inserted into the receptacle.

### DESCRIPTION OF THE PREFERRED EMBODIMENTS

### First Embodiment

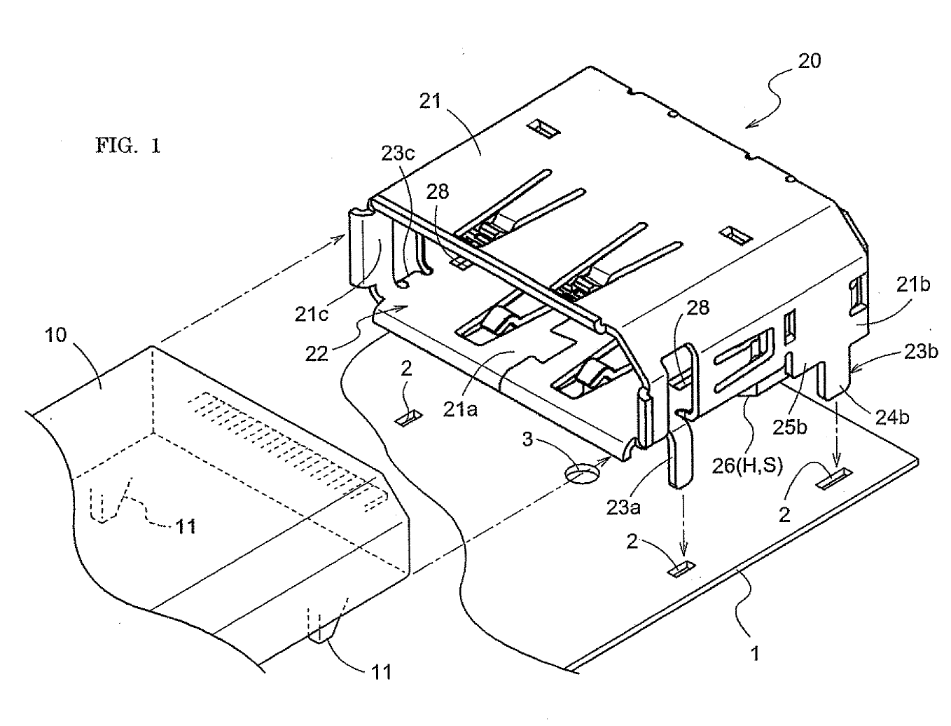

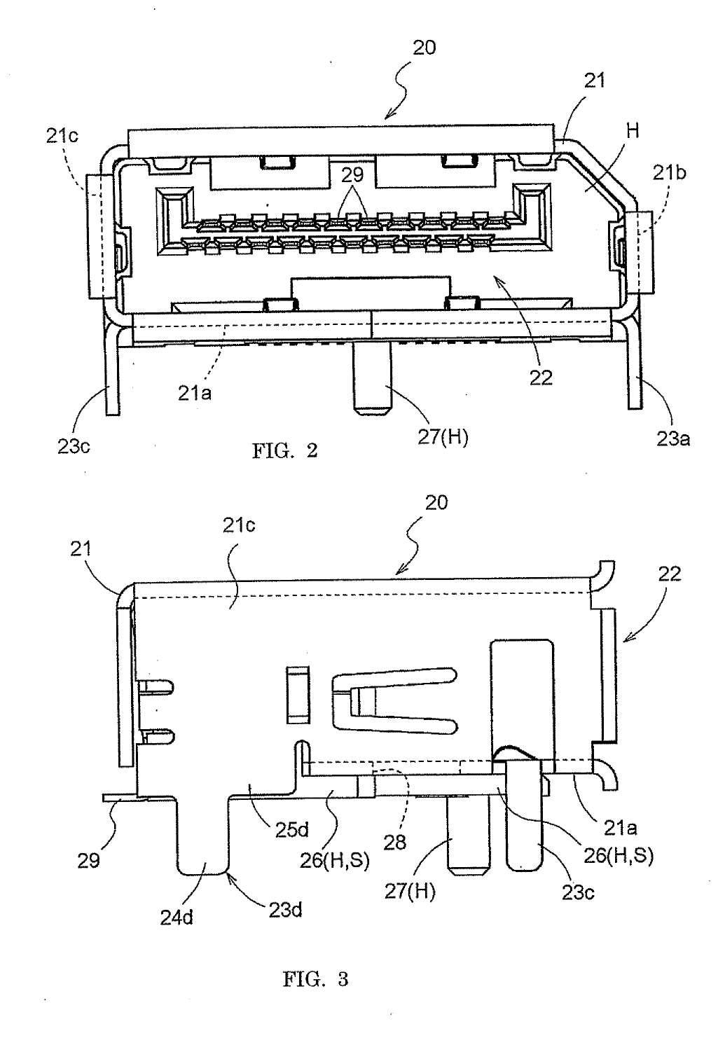

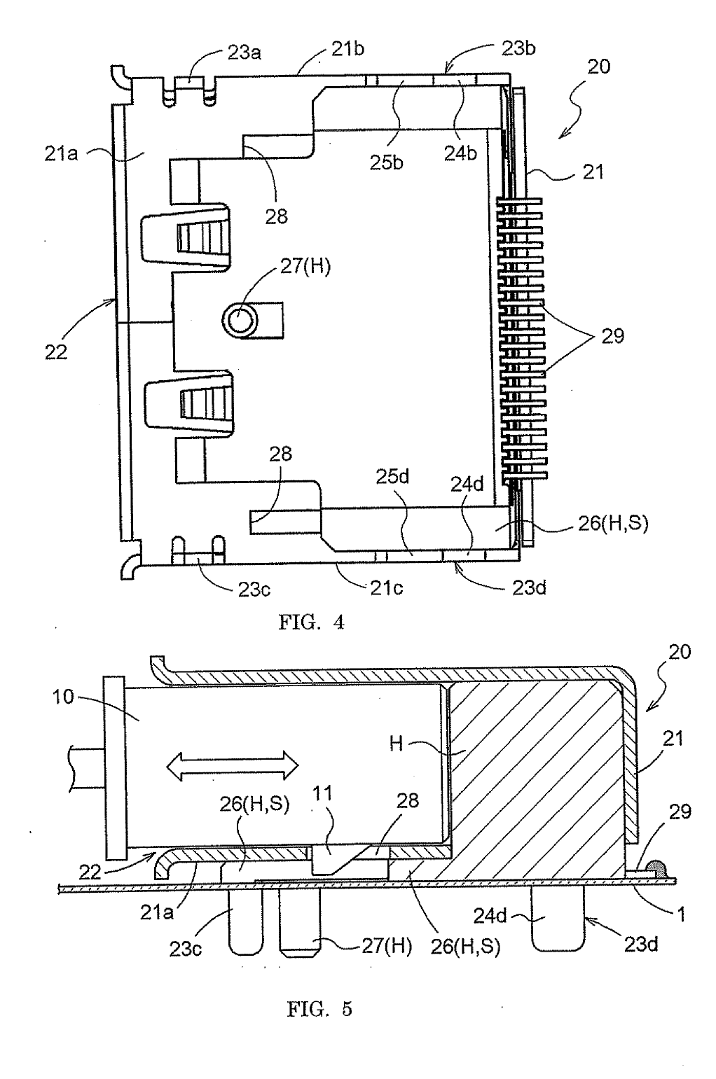

The following is a description of a connector according to the first embodiment, with reference to the accompanying drawings. The connector according to the present embodiment comprises a plug 10, and a receptacle 20 mounted on a substrate 1 and having an opening 22 into which the plug 10 is inserted. FIG. 1 is a perspective view of the receptacle 20 provided to the connector of the first embodiment. FIG. 2 is a front view of the receptacle 20, FIG. 3 is side view of the receptacle 20, and FIG. 4 is a bottom view of the receptacle 20. FIG. 5 is a cross-sectional view showing a state in which the plug 10 has been inserted into the receptacle 20.

As shown in FIGS. 1 to 5, a shield cover 21 formed by bending a metallic plate constitutes the exterior of the receptacle 20. The shield cover 21 is formed into a tubular body that is rectangular in cross-section, and accommodates a resin-formed housing H in an interior thereof. The housing H holds a receptacle-side terminal part 29. The receptacle-side terminal part 29 is held in the housing H so that one end is exposed on the interior of the receptacle 20 and another end is exposed on the exterior of the receptacle 20. When the plug 10 is inserted via the opening 22 of the shield cover 21 and pushed inside, a terminal part of the plug 10 (not shown) makes contact with the end of the receptacle-side terminal part 29 exposed on the interior of the receptacle 20. The end of the receptacle-side terminal part 29 that is exposed on the exterior of the receptacle 20 is soldered or otherwise bonded to a circuit pattern formed on the substrate 1.

The plug 10 has an engagement projection part 11 that protrudes vertically in relation to the direction in which the plug 10 is inserted into the receptacle 20. A detailed description of the structure of the plug 10 is not provided; however, the engagement projection part 11 is formed using a resin, metal, or another appropriate material. In the present embodiment, the plug 10 has two engagement projection parts 11. The shield cover 21 that constitutes the receptacle 20 has an engagement hole 28 in which the engagement projection part 11 of the plug 10 engages when the plug 10 is inserted in the receptacle 20.

The engagement hole 28 provided to the receptacle 20 is formed through the shield cover 21 in the region of the shield cover 21 that faces the substrate 1. Specifically, in the present embodiment, the engagement hole 28 is formed in a bottom surface 21a of the shield cover 21.

Accordingly, as shown in FIG. 5, when the plug 10 is inserted in the receptacle 20, the engagement projection part 11 of the plug 10 engages so as to pass through the engagement hole 28 of the receptacle 20, and the inserted state is maintained. In addition, a state of contact between the terminal part of the plug 10 and the receptacle-side terminal part 29 of the receptacle 20 is maintained.

A plurality of cutout pieces 23a, 23b, 23c, 23d (four in the present embodiment) cut out and formed from the tubular body constituting the shield cover 21 are provided to the shield cover 21. Each of the cutout pieces 23a, 23b, 23c, 23d is inserted into and locked within a plurality of through-holes 2 provided to the substrate 1. As a result, the bottom surface 21a of the shield cover 21 (tubular body) constituting the receptacle 20 is mounted facing the substrate 1.

In the present embodiment, the cutout pieces 23a, 23c are formed on the shield cover 21 nearer to the opening 22 than to the region wherein the engagement hole 28 is provided. The cutout pieces 23a, 23c are cut out and formed from side surfaces 21b, 21c of the tubular body constituting the shield cover 21, the side surfaces being vertically disposed with respect to the substrate 1. The cutout pieces 23b, 23d are cut out and formed from the bottom surface 21a of the shield cover 21.

The cutout pieces 23b, 23d are formed in the rear-end portion of the shield cover 21, on which the housing H is positioned. The cutout pieces 23b, 23d are formed so that a base part 25b, 25d is wider than a tip part 24b, 24d. Specifically, the cutout pieces 23b, 23d are formed so that the difference between the size (width) of the base part 25b, 25d and the size (width) of the tip part 24b, 24d is expressed in a step-like form. In the present embodiment, the housing H comes into contact with the substrate 1 when the receptacle 20 is mounted on the substrate 1; therefore, the base parts 25b, 25d do not come into contact with the substrate 1. The cutout pieces 23b, 23d may be formed in a tapering shape that gradually becomes smaller from the base part 25b, 25d towards the tip part 24b, 24d.

As described above, the cutout pieces 23a, 23c, which are formed in the shield cover 21 nearer to the opening 22 than to the region to which the engagement hole 28 is provided, are cut out and formed from a surface (the side surface 21b, 21c) that is different from the surface to which the engagement hole 28 is provided (bottom surface 21a).

If the cutout pieces 23a, 23c are cut out and formed from the same bottom surface 21a to which the engagement hole 28 is provided, the holes created in the shield cover 21 by cutting out portions for the cutout pieces 23a, 23c will be created in the same bottom surface 21a in which the engagement hole 28 is formed. In that case, the cutout pieces 23a, 23c will be formed in the shield cover 21 nearer to the opening 22 than to the region to which the engagement hole 28 is provided. As the plug 10 is inserted into the receptacle 20, the fact that the portions of the cutout pieces 23a, 23c have been cut out from the shield cover 21 may lead to the engagement projection part 11 of the plug 10 getting stuck in the holes formed in the shield cover 21 before the engagement projection part 11 has reached the engagement hole 28.

However, this problem does not arise in the present embodiment because the cutout pieces 23a, 23c, which are formed in the shield cover 21 nearer to the opening 22 than to the region to which the engagement hole 28 is provided, are cut out and formed from a surface (the side surface 21b, 21c) that is different from the surface to which the engagement hole 28 is provided (bottom surface 21a).

The receptacle 20 is provided with a space-retaining part S that keeps the region of the shield cover 21 to which the engagement hole 28 is provided apart from the substrate 1 by a set spacing, in a state in which the receptacle 20 is mounted on the substrate 1. In the present embodiment, the space-retaining part S is composed of spacer member 26 that is provided to the bottom surface 21a of the shield cover 21 so as to be positioned between the shield cover 21 and the substrate 1. The spacer member 26 causes the region of the shield cover 21 to which the engagement hole 28 is provided to be positioned away from the substrate 1 by a set distance. In the present embodiment, a resin material or another appropriate material is used to form the spacer member 26 as an integrated unit with the housing H. The spacer member 26 extends from the rear-end portion of the shield cover 21 to which the housing H is provided, toward the anterior opening 22. However, as shown in FIG. 4, the spacer member 26 is constructed so as to not overlap with the region to which the engagement hole 28 is provided.

The spacer member 26 has an anchoring member 27 that stretches vertically from the bottom surface toward the substrate 1. A resin material or another appropriate material is used to form the anchoring member 27 also as an integrated unit with the housing H. The anchoring member 27 is inserted into a through-hole 3 formed in the substrate 1, whereby the receptacle 20 is anchored to the substrate 1. Therefore, the receptacle 20 is mounted on the substrate 1 in a state in which the bottom surface of the spacer member 26 faces the substrate 1.

Accordingly, as shown in FIG. 5, the bottom surface 21a of the shield cover 21; i.e., the region of the shield cover 21 to which the engagement hole 28 is provided, is held positioned away from the substrate 1 by a set distance. As a result, even if the plug 10 is inserted into the receptacle 20 in a reverse-mounted state, and the engagement projection part 11 of the plug 10 is in a state of engagement with the engagement hole 28 of the shield cover 21, spacing sufficient to prevent the engagement projection part 11 from interfering with the substrate 1 is ensured between the region to which the engagement hole 28 is provided and the substrate 1. Therefore, the plug 10 and the receptacle 20 will be held in a reliable state of engagement.

### Second Embodiment

The receptacle in the connector according to the second embodiment has a structure that differs from the structure of the receptacle described in the first embodiment. A description of the connector according to the second embodiment is provided below; however, descriptions of structures that are the same as in the first embodiment have not been provided.

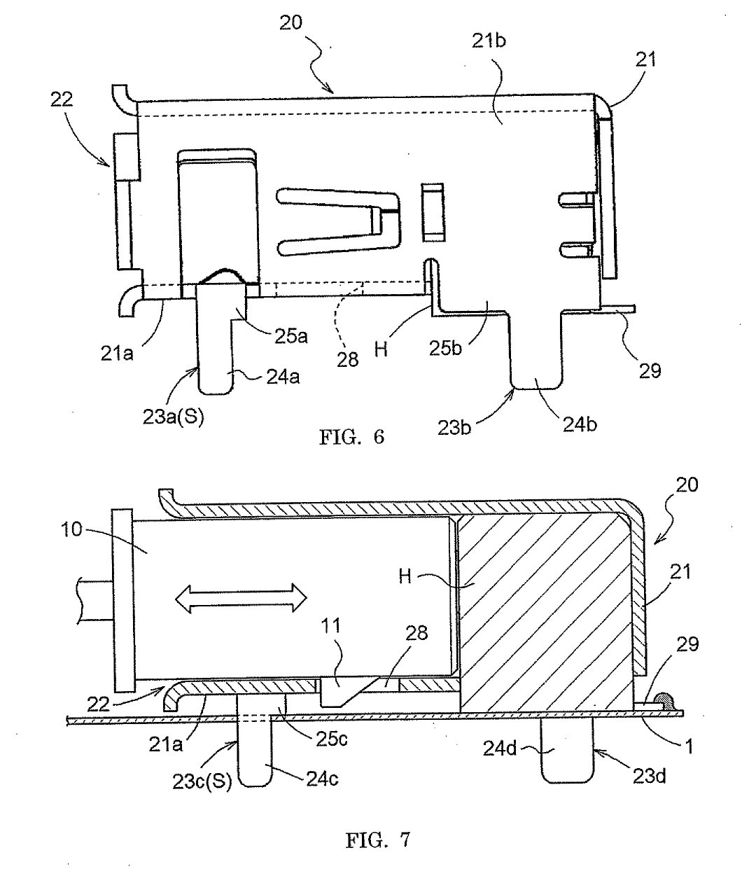

FIG. 6 is a side view of the receptacle 20 of the second embodiment. FIG. 7 is a cross-sectional view of a state in which the plug 10 has been inserted into the receptacle 20. As illustrated in the drawings, the receptacle 20 of the connector of the present embodiment does not have the spacer member 26 described in the first embodiment. Specifically, the spacer member 26 that can be used as the abovementioned space-retaining part S is not present between the shield cover 21 and the substrate 1.

The present embodiment is configured so that the base parts 25a, 25c of the cutout pieces 23a, 23c are formed wider than the tip parts 24a, 24c, whereby a part of the cutout pieces 23a, 23c will be inserted into the substrate 1 when the receptacle 20 is mounted on the substrate 1. Specifically, the present embodiment is configured so that the cutout pieces 23a, 23c, which serve as the space-retaining part S, have the base parts 25a, 25c formed wider than the tip parts 24a, 24c; the cutout pieces 23a, 23c and the substrate 1 are caused to interfere with each other when the receptacle 20 is mounted on the substrate 1; and the cutout pieces 23a, 23c are prevented from being inserted into the through-holes 2 between the tip parts 24a, 24c and the base parts 25a, 25c. As a result, as shown in FIG. 7, the region of the shield cover 21 to which the engagement hole 28 is provided is positioned away from the substrate 1 by a set distance.

Accordingly, as shown in FIG. 7, the bottom surface 21a of the shield cover 21; i.e., the region of the shield cover 21 to which the engagement hole 28 is provided, is held positioned away from the substrate 1 by a set distance. As a result, even if the plug 10 is inserted into the receptacle 20 in a reverse-mounted state, and the engagement projection part 11 of the plug 10 is in a state of engagement with the engagement hole 28 of the shield cover 21, spacing sufficient to prevent the engagement projection part 11 from interfering with the substrate 1 is ensured between the region to which the engagement hole 28 is provided and the substrate 1. Therefore, the plug 10 and the receptacle 20 will be held in a reliable state of engagement.

### Other Embodiments

(1) Examples have been described for the abovementioned embodiments in which engagement holes are provided only to the bottom surface of the shield cover; however, engagement holes may be additionally provided to other surfaces of the shield cover. For example, engagement holes may be provided to both the bottom and top surfaces of the shield cover. Moreover, engagement projection parts may be provided to the bottom and top surfaces of the plug, so as to engage with the engagement holes provided to the bottom and top surfaces of the shield cover.

Examples have been described for the abovementioned embodiments in which two engagement holes are provided to the shield cover; however, it is also possible to have a construction in which one engagement hole is provided to the shield cover, and constructions in which three or more engagement holes are provided. In such cases, an appropriate number of engagement projection parts may be provided to the plug as well, so as to engage with the engagement holes provided to the shield cover.

(2) Examples have been described for the first embodiment and second embodiment in which the cutout pieces 23a, 23c are cut out and formed from another surface besides the surface to which the engagement hole 28 is provided, the cutout pieces 23a, 23c being nearer to the opening than to the engagement hole 28. Alternatively, the cutout pieces 23a, 23c may be cut out and formed from the same surface as the surface to which the engagement hole 28 is provided. In this case, it is possible to make an adjustment to the shape of the engagement projection part 11 of the plug 10, as well as the position, shape, and other parameters relating to the cutting performed to form the cutout pieces 23a, 23c; and to cut out the portion belonging to the cutout pieces 23a, 23c so that the engagement projection part 11 of the plug 10 will either not get stuck in the holes that are formed in the shield cover 21, or, if the engagement projection part 11 does get stuck, can be removed therefrom.

(3) Examples have been describe above, in which the housing H comes into contact with the substrate 1 at the rear-end portion of the receptacle 20 (the portion to which the cutout pieces 23b, 23d are provided). According to an alternative construction, the housing H is made thin, whereby the housing H and the substrate 1 do not come into contact. In this case, the base parts 25b, 25d of the cutout pieces 23b, 23d are formed wider than the tip parts 24b, 24d, and therefore a part of the cutout pieces 23b, 23d will be inserted into the substrate 1 when the receptacle 20 is mounted on the substrate 1. Specifically, the cutout pieces 23b, 23d function as the abovementioned space-retaining part S. The base parts 25b, 25d are formed wider than the tip parts 24b, 24d; the cutout pieces 23b, 23d and the substrate I are caused to interfere with each other when the receptacle 20 is mounted on the substrate 1; and the cutout pieces 23b, 23d are prevented from being inserted into the through-holes 2 between the tip parts 24b, 24d and the base parts 25h, 25d. As a result, the entire bottom surface 21a of the shield cover 21 is positioned to be separated from the substrate 1 by a set distance.

What is claimed is:

1. A connector, comprising:
a plug, and
a receptacle mounted on a substrate, and having an opening into which the plug is inserted; the receptacle having a housing for holding a receptacle-side terminal part in an interior of a tubular shield cover that forms the opening; wherein
an engagement projection part provided to the plug engages with an engagement hole provided to a region of the shield cover of the receptacle that faces the substrate when the plug is inserted into the receptacle, and
in a state in which the receptacle is mounted on the substrate, the region of the shield cover to which the engagement hole is provided is positioned away from the substrate by a set distance.

2. The connector of claim 1, wherein
a spacer member is provided between the shield cover and the substrate.

3. The connector of claim 1, wherein
the shield cover is a tubular body that is rectangular in cross-section, and each of a plurality of cutout pieces cut out and formed from the tubular body is inserted and locked into a plurality of through-holes provided to the substrate, whereby a bottom surface of the shield cover is mounted facing the substrate.

4. The connector of claim 3, wherein
cutout pieces included among the plurality of cutout pieces and formed nearer to the opening than to the region of the shield cover to which the engagement hole is provided, are cut out and formed from a surface different from the surface to which the engagement hole is provided.

5. The connector of claim 3, wherein
base parts of the cutout pieces are formed wider than tip parts, whereby a part of the cutout pieces is inserted into the substrate when the receptacle is mounted on the substrate.

6. The connector of claim 5, wherein
cutout pieces included among the plurality of cutout pieces and formed nearer to the opening than to the region of the shield cover to which the engagement hole is provided are cut out and formed from a surface different from the surface to which the engagement hole is provided.

7. The connector of claim 3, wherein
a spacer member is provided between the shield cover and the substrate.
